(19) United States
(12) Patent Application Publication
(10) Pub. No.: US 2014/0092857 A1
(43) Pub. Date: Apr. 3, 2014

(54) METHOD AND APPARATUS FOR WIRELESS MEDIUM ACCESS

(71) Applicant: Jarkko Kneckt, Espoo (FI)

(72) Inventor: Jarkko Kneckt, Espoo (FI)

(73) Assignee: Nokia Corporation, Espoo (FI)

(21) Appl. No.: 14/122,480

(22) PCT Filed: Jun. 16, 2011
(86) PCT No.: PCT/FI2011/050575

§ 371 Date: Nov. 26, 2013

(51) Int. Cl. H04W 28/26; H04W 72/12

(52) U.S. Cl. CPC H04W 28/26; H04W 72/1242
USPC 370/329

(57) ABSTRACT

In a non-limiting and example embodiment, a method is provided for arranging multi-channel wireless communications, comprising: detecting an indication in a data unit received in a communications apparatus of the data unit being associated with a channel reservation, checking if information on the channel reservation is available in the communications apparatus, causing the communications apparatus to request information on the channel reservation in response to the information on the channel reservation not being available, and controlling wireless medium access on the basis of received channel reservation information.

### FIELD

The non-limiting example embodiments of this invention relate generally to arranging access to wireless medium, and more specifically to arranging wireless medium access in wireless networks with multi-channel capabilities.

### BACKGROUND

Various techniques exist for wireless networks to differentiate between data flows having different quality of service (QoS). For example, medium access control (MAC) layer may be provided with techniques to prioritize wireless medium access for delay-sensitive traffic. Some wireless communications technologies enable to selectively use one or more radio channels to vary data transmission rate.

### SUMMARY

Various aspects of examples of the invention are set out in the claims.

According to some embodiments, there are provided methods as defined in claims 1 and 10.

According to a second embodiment, there are provided apparatuses as defined in claims 11, 12, and 24.

According to a still further embodiment, there is provided a computer readable storage medium as defined in claim 25.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a wireless communication system;

FIGS. 2a and 2b illustrate methods according to some embodiments of the invention;

FIG. 3 describes a channel reservation procedure according to an embodiment;

FIG. 4 illustrates examples of channel reservations;

FIG. 5 illustrates format of a payload data unit;

FIGS. 6 to 9 illustrate example information elements for a channel reservation advertisement frame according to an embodiment; and

FIG. 10 illustrates an apparatus according to an embodiment.

### DETAILED DESCRIPTION

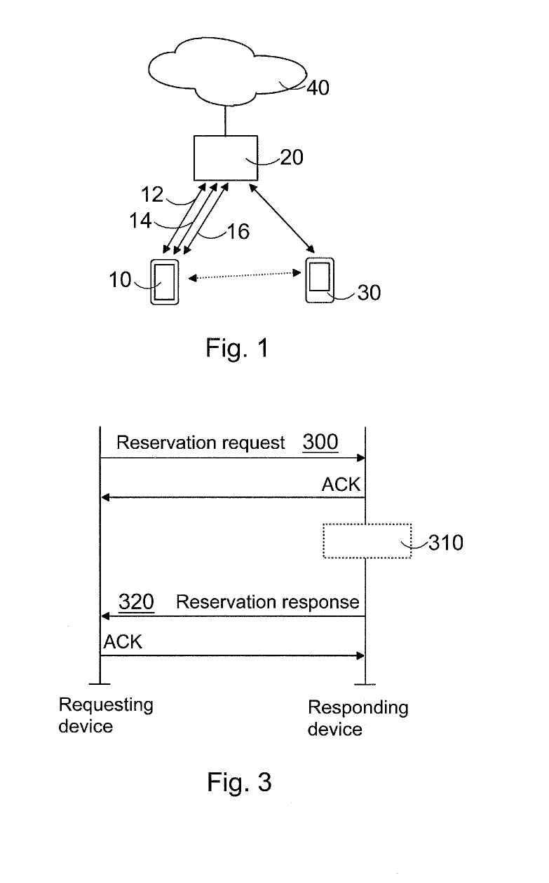

FIG. 1 illustrates an example of a wireless communication system including elements reserving network resources, such as elements supporting IEEE 802.11 features. However, it should be appreciated that the embodiments below provide only examples of technologies in which the features related to provision of channel reservation information may be applied. The presently disclosed features may be applied to other current or future networks, in which the channel reservations may be made on one or more radio channels.

Wireless devices 10, 30 may associate with an access point (AP) or base station 20 which may provide access to further networks 40. In some embodiments, the devices 10, 30 are IEEE 802.11 WLAN stations (STA). In one embodiment the wireless device 10, 30 is capable of operating as a mesh node, such as a mesh node to be specified by the IEEE 802.11s task group. In a further example embodiment the wireless device 10, 30 is capable to operate 18 in independent BSS (IBSS), and operate according to principles of IBSS network, whereby no AP 20 is involved.

The wireless device 10 may be capable of communicating via zero or more secondary channels 14, 16 in addition to a primary channel 12 defined for the device 10. In IEEE 802.11 based WLAN, a primary channel is a frequency channel in which a WLAN STA performs contention-based access to the wireless medium and in which it may receive transmissions. In some embodiments the device 10 is capable of operating under multi-channel features being developed by the IEEE 802.11ac working group. The 802.11ac working group is defining very high throughput operation mode below 6 GHz spectrum, involving use of multiple 20 MHz channels with modified channel access rules. Transmission bandwidths between 20 MHz (single channel) to 160 MHz are currently being developed. However, it will be appreciated that the present features may be applied in connection with other multi-channel access techniques.

The basic 802.11 MAC layer uses the distributed coordination function (DCF) to share the medium between multiple stations 10, 30. The DCF relies on carrier sense multiple access with collision avoidance (CSMA/CA) and handshaking with request to send (RTS) and clear to send (CTS) frames to share the medium between stations and to make probable that only a single station transmits at a time.

The IEEE 802.11e specifies an enhanced distributed channel access (EDCA) procedure to provide Quality of Service (QoS) for applications requiring real-time services. In EDCA there are eight traffic categories (TC) that are mapped to four access categories (AC). Each AC has its own transmission queue. The concept of transmission opportunities (TXOPs) was introduced in the 802.11e amendment to increase the transmission efficiency of the traffic belonging to the same AC. A TXOP is a bounded time interval in which a STA that has obtained the TXOP, i.e. a TXOP holder, maintains the right to transmit data, control, and management frames of a particular AC so long as the duration of frame sequence does not exceed the TXOP limit of that AC. The TXOP holder may protect the duration that it will maintain the medium occupied for it by setting the network allocation vector (NAV). The expected TXOP duration may be included in a duration field of RTS, CTS and payload messages. When a message with duration field >0 is received on a channel, the NAV protection is instantly established on that channel. The current 802.11 ac channel access procedure uses the EDCA on a primary channel of a STA to obtain TXOPs. A TXOP may begin after arbitration interframe space (AIFS) time and a contention window (CW) period defining the backoff period. Secondary channel(s) may be taken into use if they are idle for a point coordination function (PCF) interframe space (PIFS) time before the TXOP obtaining. The TXOP obtaining should have stronger protection, i.e. better confidence that the channels that are reserved for the data transmission do not have other transmitters operating simultaneously.

According to an aspect, a new channel reservation procedure is applied in which devices establish advance channel reservations for future channel use, and avoid transmitting during other devices' channel previously established reservations. Information of the channel reservations may be transmitted and received within devices that are capable to establish reservations at the channels. Information on the reservations may be broadcasted by channel reservation advertisements.

The channel reservation refers generally to a reservation of at least one radio channel for a time period. Instead of substantially instant medium usage as in WLAN NAV setting procedure, the channel reservation information may specify a future starting time for the reservation. The term “channel reservation” used below may thus refer to an advance channel reservation for future use, or channel pre-reservation, i,e, the reserved time does not start at the time when the advance reservation is made. In some embodiments, the presently disclosed channel reservation procedure is applied in addition to the NAV setting procedure. The channel reservation may specify a schedule for periodical frame transmissions, or may specify a single transmission event, for example. According to some embodiments of the present invention, data units, such as 802.11 physical layer convergence procedure (PLOP) protocol data units (PPDUs), are provided with an indication of the data unit being associated with an already established channel reservation. This enables a radio device to detect that an unknown reservation occurs at a channel to which the device is capable to establish reservations. There may be situations in which a device does not receive information on an established channel reservation, e.g. when entering a network after a channel reservation advertisement message has been transferred.

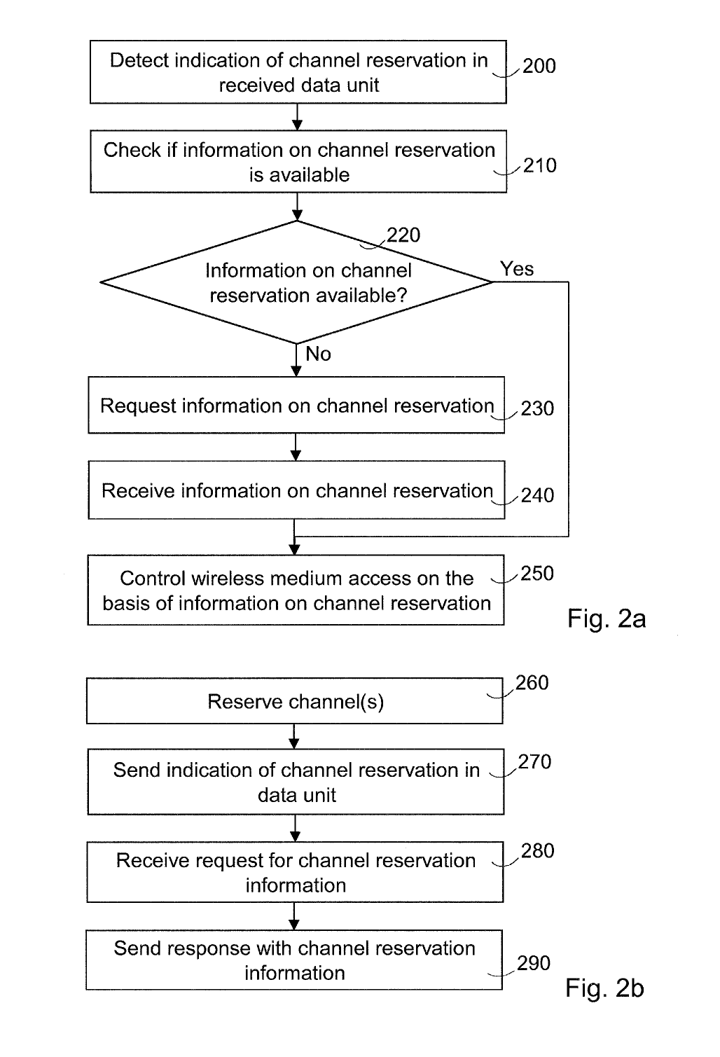

A method according to an embodiment is illustrated in FIG. 2a. For example, the method may be applied in a controller of a channel reservation enabled wireless communications device, such as an AP STA 20 and/or a non-AP WLAN STA 10, 30. An indication in a received data unit of the data unit being associated with a channel reservation is detected 200. The indication may simply merely indicate that the data unit belongs to an already established advance channel reservation, or the indication may comprise further reservation related information, such as an identifier identifying the reservation. The data unit may be a message or frame capable of carrying payload data. The indication may be obtained on the basis of a specific value of a header field of such message or frame.

The procedure checks 210, 220 if information on the channel reservation is available in the communications device in/for which the method of FIG. 2a is carried out. The channel reservation information may be available on the basis of information from earlier received advertisement message(s) and stored in a memory of the device. Channel reservation information stored in the communications device may be associated with a device identifier or address, or with some other suitable identifier also included in the data units and enabling to detect association with the reservation of the received data unit.

The communications device is caused to request 230 information on the channel reservation in response to the information on the channel reservation not being available. If an individual address, such as a MAC address, of a sender of the data unit is available, the request may be sent as a unicast message to this address. Alternatively, the request may be sent as a broadcast message. In an embodiment, further information available in the received data unit is checked and utilized for obtaining 210, 220, 230 channel reservation information. For example, a field comprising information on applied bandwidth/further channels is checked. If operation involving a plurality of channels is detected, the device may use other channels for obtaining the channel reservation information. The bandwidth or further channel information may be used to limit or hint of the channels from which the channel reservation information is obtained.

Channel reservation information is received 240 and wireless medium access is controlled 250 on the basis of the received channel reservation information. The reservation time period(s) in the received channel reservation information may be added in the channel reservations maintained in the device. The apparatus may maintain a map of time periods reserved by neighbor radio devices and avoid transmission during these reserved time periods.

In response to the wireless medium being detected as idle on the basis of a channel access control procedure applying the channel reservation information, further access control procedures may be applied in or after block 250 before allowing access to the wireless medium. In case of IEEE 802.11 networks, the channel access may be further controlled on the basis of at least one of the physical carrier sensing (CS) mechanism and the virtual CS mechanism (involving the setting of the NAV). Thus, the presently disclosed channel reservation procedures may be applied as an additional channel access control mechanism enabling channel reservations well in advance of the actual communications event, e.g. for periodical transmissions.

FIG. 2b illustrates features for a wireless communications apparatus, such as an AP STA 20 or a non-AP WLAN STA 10, 30, sending reservation information according to an embodiment of the present invention. After reserving 260 one or more channels, an indication of the channel reservation is included 270 in one or more data units transmitted during the reservation. If a request for channel reservation information is received 280, channel reservation information is sent to a requesting entity, such as an IEEE 802.11ac STA carrying out the method of FIG. 2a.

The methods of FIGS. 2a and 2b enable the communications device to obtain information on unknown reservations and avoid operations during such reservations, thus enabling to reduce disturbances.

In some embodiments, the channel reservation is for a primary channel 12 and/or at least one secondary radio channel 14, 16, such as IEEE 802.11 ac channels. At least some of the presently disclosed features may thus be applied for communicating and using secondary channel reservation information. Thus, a multi-channel capable device 10 may be arranged to monitor radio reservations on one or more secondary channels in addition to the primary channel. Secondary channel access may also be selectively controlled based on channel-specific reservation information. Thus, two or more channels associated with the channel reservation may be detected on the basis of the received data unit. Reservation information on the channel reservation may be requested 230 on the detected at least two channels.

Let us now study some further example embodiments on how the reservations may be established and how information on the reservations may be communicated.

### Reservation Enabled State

The communications device 10, 20, 30 may be arranged to operate in a specific reservation enabled state enabling channel reservation detection and indication related features. The device may be arranged to operate in the reservation enabled state for all channels or selectively for only one or more of the available channels. For example, the communications device may enter the reservation enabled state when starting operations in a new network, when detecting a reservation capable device, and/or when going to make a new reservation.

The reservation enabled communications device maintains information on channel reservations at least when it is operating in the reservation enabled state. The device checks or scans the reservations at the channels to which it desires to transmit or receive within a reservation, make new reservations and to operate in reservation enabled state. During the channel monitoring the device maintains channel reservation information on the basis of reservation indications in the received frames and/or on the basis of received reservation advertisements. The information on which channels the device operates in reservation enabled state may help other devices to create their reservation map. The device has knowledge of the reservations to which it operates in reservation enabled state.

The device may monitor multiple channels simultaneously to receive information of all reservations occurring in the channels to which the device operates in reservation enabled state. In addition to or instead of monitoring reservation advertisements on monitored channels, the device may obtain PLOP headers of transmissions in the monitored channels. The device may synchronize with a transmission, receive a PLOP header of the transmission, and ignore the actual payload of the transmission. With this procedure, the device receives indications of all ongoing transmissions at the monitored channels and the device may create a map of the reservations in the monitored channels.

In some embodiments, the channel reservation is an advance reservation of at least one time interval and established by a channel reservation procedure involving reservation request and response signalling. As illustrated in an example reservation procedure of FIG. 3, a reserving device transmits 300 a reservation request frame to a target of the reservation. The reservation request comprises parameters for the new reservation.

The target device may acknowledge (ACK) the received reservation request 300 and processes 310 the request. The target may check existing reservations it is aware of, to detect any conflict. It may be that the target device is not operating in reservation enabled state for all the channels requested to be reserved. The target device may be arranged to first set itself to the reservation enabled state at all requested channels before it can accept the reservation.

The target device responds with a reservation response 320 indicating if the requested reservation is accepted or rejected. If the reservation is accepted, the devices update their information storages by the new reservation.

When the device operates in reservation enabled state, the device indicates in its reservation advertisements, the channels to which it is capable to make reservations and which reservations it has tracked. A WLAN device may be arranged to track at least reservations of operating channels of its basic service set (BSS). This enables the device to avoid transmissions on top of overlapping reservations. After observing the ongoing reservations, the device may indicate that it operates in reservation enabled state for the monitored channels and is capable to establish and accept reservations to the monitored channels.

### Reservation Advertising

The reservation enabled communication devices may advertise at least their own advance reservations to other devices by reservation advertisement frames. After a new reservation has been established, the device includes reservation information in the reservation advertisement frames. As already indicated, the present channel reservation may be applied in addition to the EDCA procedure, and the channel reservation advertisements may be different from RTS/CTS messages.

The communications device may include in a reservation advertisement reservation information of other devices' reservations. For example, the reservation request 300 may comprise a reservation advertisement based on reservation information in earlier received reservation advertisements. Channel reservation advertisements may be transmitted in a beacon frame, probe response frame, a reservation frame and/or another suitable frame, such as a new frame for responding 280, 320 to a channel reservation request 240.

The reservation advertisement frames may comprise one or more of the reservation(s) in which the advertisement transmitting device is a transmitter and/or receiver, the reservation(s) of its neighboring device(s) in which the neighboring device(s) is/are transmitter and/or receiver, received reservation advertisement frames, the channels to which the advertisement transmitting device operates in reservation enabled state.

The reservation advertisement frames may also indicate the primary channel of the advertisement transmitting device. The device transmits the reservation advertisement frames to its primary channel, but transmission of the advertisement frames may be arranged also to secondary channels in which the device operates in reservation enabled state. If the device detects a reservation that uses at least one channel to which the device operates in reservation enabled state and at least one other channel that is not within the reservation enabled channels of the device, the device may transmit a reservation advertisement to the primary channel of the overlapping reservation transmitter or to the overlapping channel by applying a specific time interval for overlapping reservation advertisements, which may be referred to as e.g. a dot11MaximumOverlapReservation AdvertisementInterval.

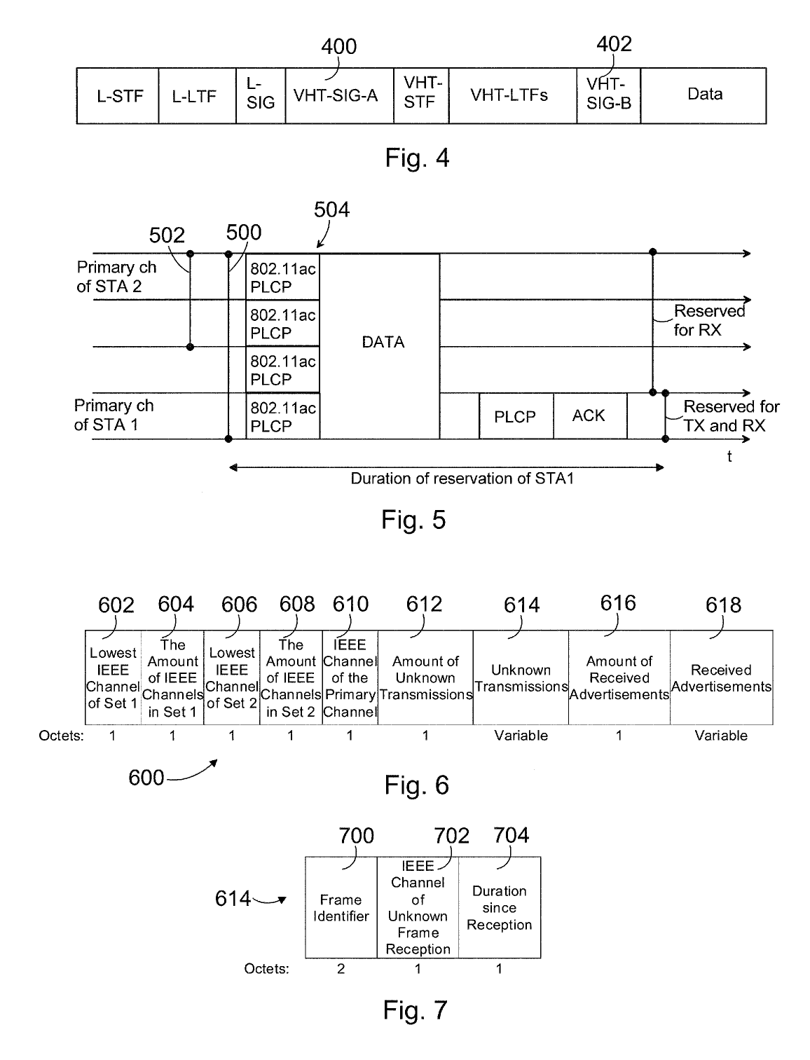

The reservation advertisement frames may be transmitted periodically. In case of IEEE 802.11ac networks, a reservation advertisement may be transmitted as a very high throughput (VHT) PPDU or as a duplicate high throughput (HT) PPDU to multiple channels to distribute the reservation advertisements to multiple channels. FIG. 4 illustrates fields of the VHT PPDU currently planned for IEEE 802.11ac. The duplicate HT-PPDU is transmitted if legacy devices operate at channels to which the reservation is transmitted.

In an embodiment, a request for reservation advertisement is sent in block 230 of FIG. 2a and received in block 280 of FIG. 2b. The information on the channel reservation may be transmitted 290 and received 240 in a channel reservation advertisement.

Detecting Already Established Reservations on the Basis of Received Payload Data Units

In an embodiment, the indication on channel reservation is included 270 in a part of reservation field of a payload data unit. With reference to FIG. 4, such field may be included in PLOP header portion of 802.11ac PPDUs. This enables 802.11ac capable devices to detect if the PPDU is part of the reservation. Table 1 describes fields of the VHT PPDU of FIG. 4.

TABLE 1

| FIELD | DESCRIPTION |
|---|---|
| L-STF | Non-HT Short Training field |
| L-LTF | Non-HT Long Training field |
| L-SIG | Non-HT SIGNAL field |
| VHT-SIG-A | VHT Signal A field |
| VHT-STF | VHT Short Training field |
| VHT-LTF | VHT Long Training field |
| VHT-SIG-B | VHT Signal B field |
| Data | The Data field includes the PSDU |
| | (PLCP Service Data Unit) |

In an embodiment, the part of reservation field is included in the VHT-SIG A field 400, e.g. in bit 23. In another example embodiment, the part of reservation field is included in VHT-SIG B field 402, e.g. in bit 9.

Each transmitted PPDU may thus have the part of reservation field. The field may be set to 1 to indicate that the transmitted PPDU is part of the reservation. Otherwise the field is set to 0. During the channel monitoring the device receives (200) the PLOP headers of the transmitted frames and checks if the part of the reservation field is set. However, it will be appreciated that the PPDU format may change, and that the indication may be included in various other fields and in other payload data unit formats.

When an 802.11ac capable device 10, 20, 30 operating in reservation enabled state receives a PPDU with the part of the reservation field set to 1, the device may in block 210 check if it has received an advertisement of a reservation to which the PPDU belongs. The part of the reservation field enables at least those devices whose primary channel is part of the reserved channels to detect transmissions belonging to a reservation.

When a device not operating in the reservation enabled state for any channel receives a frame with the part of the reservation field set to 1, it may notice that other devices have established reservations and the device may start to use the reservation scheme.

As already indicated, the device may check further information in order to obtain the channel reservation information. The device can detect the addresses of the transmitter and receiver by checking the MAC address of the PPDU, or the device may get a hint of the receiver and transmitter from the PLOP header of the frame. The device may be arranged to check the applied bandwidth on the basis of value of the BW information element of the VHT-SIG A field. The Group ID and Partial AID field of the N_{STS} (Number of space time streams) information element may be checked to get information for determining a receiver of the PPDU.

If a device receiving a PPDU with reservation indication does not have a reservation established for the channel in which the PPDU was received, a reservation may be established for the channel and the time.

An example of detecting absent reservation information is illustrated in FIG. 5. A first WLAN device STA1 maintains 500 reservations for four 802.11ac channels, i.e. for 80 MHz band. Another WLAN device STA2 maintains 502 reservations for two channels, i.e. for 40 MHz band. For some reason, reservation signaling of the STA1 was not received by STA2. During PPDU transmission 504 of the STA1 transmission, STA2 detects that the STA1 transmission is part of the STA1 reservation. The STA2 obtains more information of the ongoing reservations, e.g. by applying the features illustrated above.

In some embodiments, the channel reservation is a single-direction channel reservation, which means that the reservation applies only to transmission or reception. The channel reservation information indicates the direction of the reservation. The device may be arranged to detect the direction of the channel reservation and control access to the wireless medium on the basis of the direction of the channel reservation. The device may thus maintain information on interfering TX and RX times separately. This facilitates more efficient use of the radio resources; at least partially overlapping reservations may be allowed. As illustrated in FIG. 5, the primary channel of the STA1 may be reserved for transmission and reception, whereas the secondary channels of the STA1 are reserved only for reception.

In an embodiment, a device receiving 200 a PDU with reservation indication indicates that it has detected an unknown reservation. Such indication may be included in an advertisement frame of the device. Thus, e.g. if the device has not received 240 the requested channel reservation information, the device can inform other devices of the unknown channel reservation.

Example Contents for Reservations Advertisement Frames

FIG. 6 illustrates example contents for a reservation advertisement frame 600. Some or all of the example fields may be included in an advertisement frame.

The Lowest IEEE Channel of Set 1 602 may be an unsigned integer and indicates the lowest IEEE channel number of the reservation set 1. The Amount of IEEE Channels in Set 1 604 may be an unsigned integer and indicates the amount of the IEEE channels in the Set 1. The Lowest IEEE Channel of Set 2 606 may be an unsigned integer and indicates the lowest IEEE channel number of the reservation set 2. The field may be set to 0 to indicate that Channel Set 2 is not present.

The Amount of IEEE Channels in Set 2 608 may be an unsigned integer and indicates the amount of the IEEE channels in the set 2. The field may be set to 0 to indicate that Channel Set 2 is not present. If also these fields 606 and 608 are provided with channel information, the advertising device is aware of the reservation situation of the IEEE channel sets 1 and 2. The IEEE Channel of the Primary Channel 610 may be an unsigned integer and indicates the primary channel of the reservation advertisement frame transmitter.

The Amount of Unknown Transmissions field 612 may be an unsigned integer and may be applied to indicate the amount of received PPDUs that have been detected to belong to a reservation, but the advertising device has not maintained any reservation for the time. The advertising device may indicate multiple unknown reservations if frames with the same identifier are received at separate times.

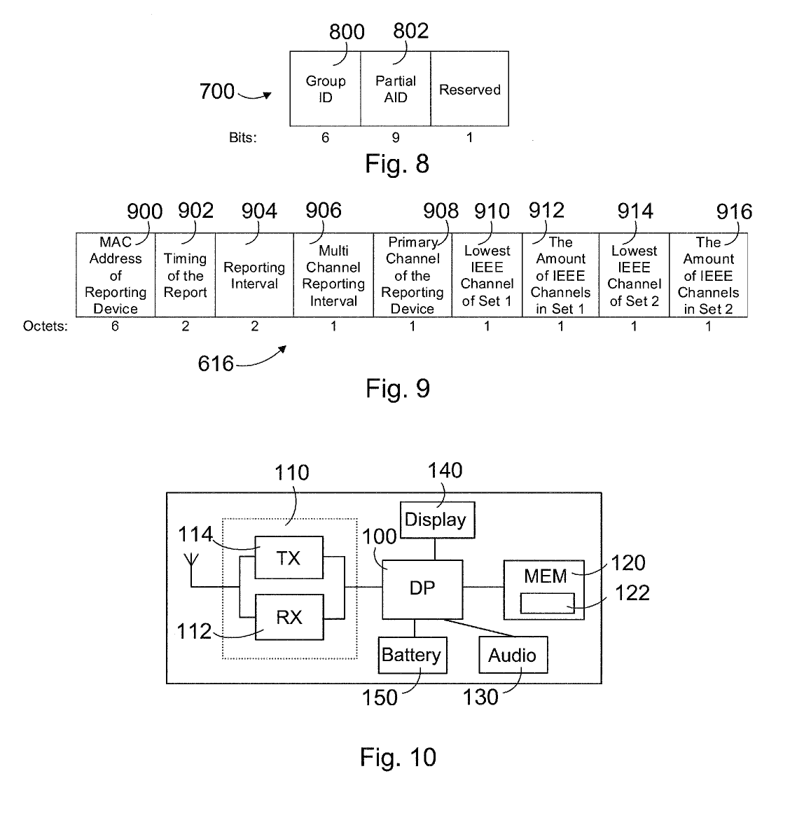

FIG. 7 illustrates example contents of the Unknown Transmissions field 614. FIG. 8 illustrates example contents of the Frame Identifier field 700 of the Unknown Transmissions field 614. The Group ID field 800 may be set to the value of the Group ID field of the unknown frame. The Partial AID (Association ID) field 802 may be set to the value of the Partial AID (bits 13-21 of the VHT-SIG A). The device may include the Group ID and Partial AID of the PPDU and the time of the PPDU transmission in unknown transmissions field.

Returning to FIG. 7, the IEEE Channel of Unknown Frame Reception field 702 may be set to the IEEE channel number in which the unknown frame was received when no reservation was ongoing. The Duration since Reception field 704 may indicate the duration in units of 32 microseconds since the Reception of unknown frame was started.

Returning to FIG. 6, the Amount of Received Advertisements field 616 may be an unsigned integer and may be applied to indicate the amount of Advertisement Report fields.

FIG. 9 illustrates example contents of the Received Advertisements field 618. The MAC Address of Reporting Device field 900 may be set to the MAC address of the device that sent the reservation advertisement. The timing of the Report field 902 may indicate the duration in units of 32 microseconds from the DTIM beacon to the Reservation Advertisement frame transmission. The Reporting interval field 904 may indicate the amount of 32 micro seconds between consecutive Reservation Advertisement frames. The Multichannel Reporting Interval field 906 may indicate the interval of the Reservation Advertisement frames that is the maximum interval for duplicating the Reservation Advertisement frame to channels in which the device is capable to reserve. If the device does not report to multiple channels, the field may be set to 0.

The Primary Channel of the Reporting Device field 908 may be an unsigned integer and indicates the primary channel of the reporting device. The Lowest IEEE Channel of Set 1 field 910 may be an unsigned integer and indicates the lowest IEEE channel number of the reservation set 1. The Amount of IEEE Channels in Set 1 field 912 may be an unsigned integer and indicates the amount of the IEEE channels in the Set 1. The Lowest IEEE Channel of Set 2 field 914 may be an unsigned integer and indicates the lowest IEEE channel number of the reservation set 2. The field is set to 0 to indicate that Channel Set 2 is not present. The Amount of IEEE Channels in Set 2 field 916 may be an unsigned integer and indicates the amount of the IEEE channels in the set 2. The field may be set to 0 to indicate that Channel Set 2 is not present. If fields 910 to 916 are provided with channel information, the advertised device is aware of the reservation situation of the IEEE channel sets 1 and 2.

It is to be appreciated that the advertisement frames may comprise further information elements, which may be used instead of or in addition to above information elements. For example, in the embodiment applying single direction channel reservations, the advertisement frame may comprise an information element for times and channels in which the advertising device transmits, an information element for times and channels in which the advertising device receives, and one or more information elements for reporting detected interference.

According to an embodiment, the channel reservation mechanism is based on a coordinated channel access mechanism for mesh networks. Such channel access mechanism is under development in IEEE 802.11s as an additional and optional coordination function called mesh coordination function (MCF), usable only in a mesh BSS (MBSS). In an embodiment, at least some of the features under development for the MCCA are applied for the channel reservation mechanism for reserving IEEE 802.11ac channels.

The MCF has both a contention-based channel access and contention free channel access mechanism. The contention based mechanism is EDCA and the contention free mechanism is called the MCF coordinated channel access (MCCA) that optimizes frame exchanges in the MBSS.

Under the MCF, the basic unit of allocation of the right to transmit onto the WM is the TXOP. Each TXOP is defined by a starting time and a defined maximum length. Under MCF, there are two types of TXOPs: EDCA TXOPs and MCCA TXOPs. The EDCA TXOP is obtained by a mesh STA winning an instance of EDCA contention. The MCCA TXOP is obtained by a mesh STA gaining control of the WM during an MCCA opportunity MCCAOP. The MCCAOP is an advance reservation of a time interval for its transmission by means of an MCCA Opportunity Reservation. The mesh STA transmitting an MCCAOP Setup Request frame to initiate an advance reservation is the MCCAOP owner of the MCCAOP reservation defined in this setup. The receivers of the MCCAOP Setup Request are the MCCAOP responders. The MCCAOP owner and the MCCAOP responders advertise this advance reservation to their neighbors via MCCAOP Advertisements. The MCCA enabled neighbor mesh STAs that could cause interference to transmissions during these reserved time periods, or that would experience interference from them, do not initiate a transmission during these reserved time periods. During its MCCAOP, the MCCAOP owning mesh STA obtains a TXOP by winning an instance of EDCA contention. Because of its advance reservation, the MCCAOP owning mesh STA experiences no competition from other MCCA enabled neighbor mesh STAs. At the start of an MCCAOP, an EDCA function (EDCAF) of the MCCAOP owner replaces current AIFSN, contention window minimum (CWmin), and contention window maximum (CWmax) values with MCCA access parameters. In order to use MCCA, a mesh STA maintains synchronization with its neighboring mesh STAs.

The MCCAOP procedures and frames may be applied as such or in modified form to arrange the channel reservation, and in a further embodiment reservation of 802.11ac channels and to maintain and indicate a set of channels in which the device operates in reservation enabled state. It should be noted that neighboring devices or devices operating in the same mesh BSS may maintain a different set of channels to which they operate in reservation enabled state. Thus, the channel reservation may be requested 230, 300 by a coordinated channel access opportunity setup request and advertised by a coordinated channel access opportunity advertisement.

In an embodiment, a reservation allocation vector (RAV) mechanism is applied on the basis of the channel reservation information, and reservation allocation vector protection is detected 200 on the basis of the indication in the received payload data unit. The channel reservation may thus trigger a reservation allocation vector (RAV) which may indicate the intended reservation to the other devices receiving the reservation request message, the reservation response message, and/or the reservation advertisement message. The RAV may have properties similar to the NAV, e.g. it may prevent subsequent overlapping reservations of the channel(s) (unless they fulfill rules for allowing overlapping). In an embodiment, the RAV setting is applied for 802.11ac channels. An index of future coordinated channel access opportunities may thus be maintained on the basis of coordinated channel access opportunity reservations. Busy medium indication is set for each coordinated channel access opportunity for the duration of the coordinated channel access opportunity.

In an embodiment, at least some of the above illustrated features are applied for detecting 200 an established MCCAOP and obtain 230, 240 information on an unknown MCCAOP.

While embodiments of the invention are described in the context of the above-described topologies of IEEE 802.11 and, particularly, IEEE 802.11 ac, it should be appreciated that other embodiments of the invention are applicable to networks based on other specifications, e.g. other versions of the IEEE 802.11, WiMAX (Worldwide Interoperability for Microwave Access), UMTS LTE (Long-term Evolution for Universal Mobile Telecommunication System), and other networks having cognitive radio features, e.g. wireless medium sensing features and adaptiveness to coexist with radio access networks based on different specifications and/or standards.

Embodiments of the present invention and means to carry out these embodiments in an apparatus, such as the wireless (mobile) communications device 10, 30 and/or a wireless access device 20, may be implemented in software, hardware, application logic or a combination of software, hardware and application logic. In an example embodiment, the application logic, software or an instruction set is maintained on any one of various conventional computer-readable media.

In one example embodiment, there may be provided circuitry configured to provide at least some functions illustrated above, such as the features illustrated in FIG. 2a and/or 2b. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although single enhanced entities were depicted above, it will be appreciated that different features may be implemented in one or more physical or logical entities. For instance, the apparatus may comprise a specific functional module for carrying one or more of the blocks in FIG. 2a and/or 2b. In some embodiments, a chip unit or some other kind of hardware module is provided for controlling a radio device, such as the wireless device 10 or an AP 20.

In some embodiments, the channel reservation information in the payload data unit and/or advertisement frame comprise or are stored as data structures affecting operation of one or more processors.

FIG. 10 is a simplified block diagram of high-level elements of a wireless communications device according to an embodiment. The device may be configured to function as the wireless device 10, 30 and carry out at least some of the functions illustrated above for the wireless device 10, 30.

In general, various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 100 with at least one data processor and a memory 120 storing a program 122. The memory 120 may be implemented using any data storage technology appropriate for the technical implementation context of the respective entity. By way of example, the memory 120 may include non-volatile portion, such as EEPROM, flash memory or the like, and a volatile portion, such as a random access memory (RAM) including a cache area for temporary storage of data. The DP 100 can be implemented on a single-chip, multiple chips or multiple electrical components. The DP 100 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 110 with a transmitter 114 and a receiver 112. The device may be configured to operate as an IEEE 802.11 ac STA, AP, or mesh point. It will be appreciated that in many cases a mobile communications device is a multimode device. By way of illustration, the electronic device may comprise radio units 110 to operate in accordance with any of a number of second, third and/or fourth-generation communication protocols or the like. For example, the device may operate in accordance with one or more of GSM protocols, 3G protocols by the 3GPP, CDMA2000 protocols, 3GPP Long Term Evolution (LTE) protocols, short-range wireless protocols, such as the Bluetooth, and the like. The device may comprise multiple transmitting and/or receiving antenna elements (not shown in FIG. 10).

The DP 100 may be arranged to receive input from UI input elements, such as an audio input circuit connected to a microphone and a touch screen input unit, and control UI output, such as audio circuitry 130 connected to a speaker and a display 140 of a touch-screen display. The device also comprises a battery 150, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 10. For example, the device may comprise a power amplification chip for signal amplification, a baseband chip, and possibly further chips, which may be coupled to one or more (master) data processors.

An embodiment provides a computer program embodied on a computer-readable storage medium. The program, such as the program 122 in the memory 120, may comprise computer program code configured to, with the at least one processor, cause an apparatus, such as the device 10, 20, 30 or the device of FIG. 10, to perform at least some of the above-illustrated channel reservation information related features illustrated in connection with FIGS. 2a to 9. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 10. A computer-readable medium may comprise a tangible and non-transitory computer-readable storage medium that may be any media or means that can contain or store the instructions for use by or in connection with an instruction execution system, apparatus, or device, such as a computer.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting an indication in a data unit received in a communications apparatus of the data unit being associated with a channel reservation,
checking if information on the channel reservation is available in the communications apparatus,
causing the communications apparatus to request information on the channel reservation in response to the information on the channel reservation not being available, and controlling wireless medium access on the basis of received channel reservation information.

2. The method of claim 1, wherein the channel reservation is an advance reservation of at least one time interval beginning at a time specified by the information on the channel reservation and obtained by a channel reservation procedure involving reservation request and response signalling.

3. The method of claim 1, wherein a request for reservation advertisement is sent on the basis of the received data unit, and the information on the channel reservation is received in a reservation advertisement.

4. The method of claim 1, wherein a reservation allocation vector mechanism is applied on the basis of the information on the channel reservation, and reservation allocation vector protection is detected on the basis of the indication in the received data unit.

5. The method of claim 4, wherein the reservation allocation vector mechanism comprises: maintaining an index of future coordinated channel access opportunities on the basis of coordinated channel access opportunity reservations, and
setting busy medium indication for each coordinated channel access opportunity for the duration of the coordinated channel access opportunity.

6. The method of claim 1, wherein, in response to the wireless medium being detected as idle on the basis of a channel access control procedure applying the information on the channel reservation, access to the wireless medium is controlled on the basis of at least one of a physical carrier sensing mechanism and a virtual carrier sensing mechanism.

7. The method of claim 1, wherein the channel reservation is a single-direction channel reservation,
the direction of the channel reservation is detected, and
access to the wireless medium is controlled on the basis of the direction of the channel reservation.

8. The method of claim 1, wherein two or more channels associated with the channel reservation are detected on the basis of the received data unit, and
information on the channel reservation is requested on the detected at least two channels.

9. The method of claim 1, wherein the indication is included in a part of reservation field of a payload data unit of a physical layer convergence procedure frame.

10. A method, comprising:
causing a wireless apparatus to transmit a data unit comprising an indication of the data unit being associated with a channel reservation,
detecting a received request for information on the channel reservation in response to the information on the channel not being available, and
causing the wireless apparatus to transmit information on the channel reservation in response to the received request.

11. An apparatus, comprising
at least one processor; and
at least one memory including computer program code,
the at least one memory and the computer program code being configured to, with the at least one processor, cause the apparatus at least to:
detect an indication in a data unit received in a communications device, of the data unit being associated with a channel reservation,
check if information on the channel reservation is available in the communications device, and
cause the communications device to: request information on the channel reservation in response to the information on the channel reservation not being available and control wireless medium access on the basis of received channel reservation information.

12. (canceled)

13. The apparatus of claim 11, wherein the channel reservation is an advance reservation of at least one time interval beginning at a time specified by the information on the channel reservation and obtained by a channel reservation procedure involving reservation request and response signalling.

14. The apparatus of claim 11, wherein the apparatus is configured to send a request for reservation advertisement on the basis of the received data unit, and
the apparatus is configured to receive the information on the channel reservation in a reservation advertisement.

15. The apparatus of claim 11, wherein the apparatus is configured to apply a reservation allocation vector mechanism on the basis of the information on the channel reservation, and
the apparatus is configured to detect reservation allocation vector protection on the basis of the indication in the received data unit.

16. The apparatus of claim 15, wherein the reservation allocation vector mechanism comprises: maintaining an index of future coordinated channel access opportunities on the basis of coordinated channel access opportunity reservations, and
setting busy medium indication for each coordinated channel access opportunity for the duration of the coordinated channel access opportunity.

17. The apparatus of claim 11, wherein the apparatus is configured to control access to the wireless medium on the basis of at least one of a physical carrier sensing mechanism and a virtual carrier sensing mechanism in response to detecting the wireless medium to be idle on the basis of a channel access control procedure applying the information on the channel reservation.

18. The apparatus of claim 11, wherein the channel reservation is a single-direction channel reservation,
the apparatus is configured to detect the direction of the channel reservation, and
the apparatus is configured to control access to the wireless medium on the basis of the direction of the channel reservation.

19. The apparatus of claim 11, wherein the apparatus is configured to detect two or more channels associated with the channel reservation on the basis of the received data unit, and
the apparatus is configured to request information on the channel reservation on the detected at least two channels.

20. The apparatus of claim 11, wherein the apparatus is configured to include the indication in a part of reservation field of a payload data unit of a physical layer convergence procedure frame.

21. The apparatus of claim 11, wherein the apparatus is wireless communications device configured to operate as a wireless local area network station.

22-23. (canceled)

24. An apparatus, comprising
at least one processor; and
at least one memory including computer program code,
the at least one memory and the computer program code being configured to, with the at least one processor, cause the apparatus at least to:
cause a wireless apparatus to transmit a data unit comprising an indication of the data unit being associated with a channel reservation,
detect a received request for information on the channel reservation in response to the information on the channel not being available, and
cause the wireless apparatus to transmit information on the channel reservation in response to the received request.

25. (canceled)
